(19) United States
(12) Patent Application Publication
(10) Pub. No.: US 2007/0133124 A1
(43) Pub. Date: Jun. 14, 2007

(54) Disk clamp and hard disk drive including the same

(75) Inventors: Youn-tai Kim, Yongin-si (KR); Back-ho Heo, Suwon-si (KR); Shi-jung Kim, Seoul (KR); Sung-wook Kang, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/634,887

(22) Filed: Dec. 7, 2006

(30) Foreign Application Priority Data
Dec. 8, 2005 (KR) 2005-120066

(51) Int. Cl. G11B 17/02

(52) U.S. Cl. 360/99.12

(57) ABSTRACT

A disk clamp to affix a disk of a hard disk drive to a spindle motor. The disk clamp includes a coupling part coupled to an upper portion of the spindle motor with screws, a pressing part provided outside the coupling part to press the disk against the spindle motor, and an elastic deformation part provided between the coupling part and the pressing part and adapted to be flexed in an elastically restorable manner, when the screws are tightened, to impart a pressing force to the pressing part. A hard disk drive including the disk clamp is also provided.

### CROSS-REFERENCE TO RELATED APPLICATIONS

This application claims priority under 35 U.S.C. 119 §(a) from Korean Patent Application No. 10-2005-0120066, filed on Dec. 8, 2005, in the Korean Intellectual Property Office, the disclosure of which is incorporated herein in its entirety by reference.

### BACKGROUND OF THE INVENTION

1. Field of the Invention

The present general inventive concept relates to a hard disk drive, and more particularly, to a disk clamp that secures a disk used as a data recording medium to a spindle motor as a drive means, and a hard disk drive including the disk clamp.

2. Description of the Related Art

Hard disk drives (HDDs) are an example of auxiliary storage devices mounted to host systems, such as computers, mobile phones, MP3 players and set-top boxes, and are provided with a magnetic head that reads data stored in a disk as a data recording medium or writes new data to the disk.

FIG. 1 is a cross-sectional view illustrating an example of a conventional disk clamp 10. Referring to FIG. 1, the disk clamp 10, which serves to affix a disk 1 as a data recording medium to a spindle motor 5 as a rotary drive means, is provided with a center bore 11 through which a shaft 6 of the spindle motor 5 is inserted, a coupling part 12 provided at a periphery of the bore 11 and a pressing part 15 provided around the coupling part 12. Disposed along the coupling part 12 is a plurality of screw passage holes 13 that allow a plurality of screws 20 to pass therethrough. The disk clamp 10 is fixedly secured to a motor hub 8 by inserting the screws 20 through the screw passage holes 13 and screwing them into the motor hub 8, which functions as a rotator of the spindle motor 5. The pressing part 15 of the disk clamp 10 holds down the disk 1 to thereby affix it to the motor hub 8. The coupling part 12 is not planar, but has a concave shape. This ensures that, as the screws 20 are tightened, the coupling part 12 is elastically deformed into a planar configuration, thus causing the bottom surface of the coupling part 12 to make close contact with the top flat surface of the motor hub 8.

In the conventional disk clamp 10 described above, however, the degree of elastic deformation that the coupling part 12 undergoes at the time of tightening the screws 20 is so great that the coupling part 12 has a strong tendency to restore its original shape. This increases the possibility that the screws 20 are loosened inadvertently. Such an inability of the screws 20 to tighten the coupling part 12 in a reliable manner may ultimately result in the disk 1 being pressed with an insufficient pressing force. As a consequence, it is highly likely that a disk slip may occur, a phenomenon in which the disk 1 slides in a horizontal direction while rotating. Furthermore, the respective screws 20 may be tightened with uneven forces and hence the pressing part 15 fails to apply uniform pressing forces to the disk 1, thereby causing partial distortion to the disk 1 at its inner circumferential part.

### SUMMARY OF THE INVENTION

The present general inventive concept provides a disk clamp that minimizes the extent of elastic deformation of a coupling part that makes contact with a spindle motor, and a hard disk drive including the disk clamp.

Additional aspects and advantages of the present general inventive concept will be set forth in part in the description which follows and, in part, will be obvious from the description, or may be learned by practice of the general inventive concept.

The foregoing and/or other aspects and utilities of the general inventive concept are achieved by providing a disk clamp which may affix a disk of a hard disk drive to a spindle motor, which includes a coupling part coupled to an upper portion of the spindle motor with screws, a pressing part provided outside the coupling part to press the disk against the spindle motor, and an elastic deformation part provided between the coupling part and the pressing part and adapted to be flexed in an elastically restorable manner, when the screws are tightened, to impart a pressing force to the pressing part.

The coupling part may have a bottom planar surface corresponding to a top planar surface of the spindle motor.

The pressing part may have a disk contact surface having a downwardly convex shape.

The elastic deformation part may be provided with a groove facilitating the flexing of the elastic deformation part.

The groove may be formed in a bottom surface of the elastic deformation part.

No groove may be formed in a top surface of the elastic deformation part.

The elastic deformation part may have a smaller thickness than the coupling part and the pressing part.

The pressing part may have a greater thickness than the coupling part and the elastic deformation part.

The coupling part may have with a plurality of screw passage holes disposed at an equal angular spacing.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating an example of a conventional disk clamp;

FIG. 2 is a perspective view illustrating a hard disk drive, according to an embodiment of the present general inventive concept;

FIGS. 3 and 4 are perspective and cross-sectional views illustrating a disk clamp, according to another embodiment of the present general inventive concept;

FIGS. 5 through 7 are cross-sectional views illustrating disk clamps, according to other embodiments of the present general inventive concept; and

FIG. 8 is a graph illustrating the magnitude of pressing forces at specific points of a pressing part in a case in which disk clamps are coupled to a spindle motor.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

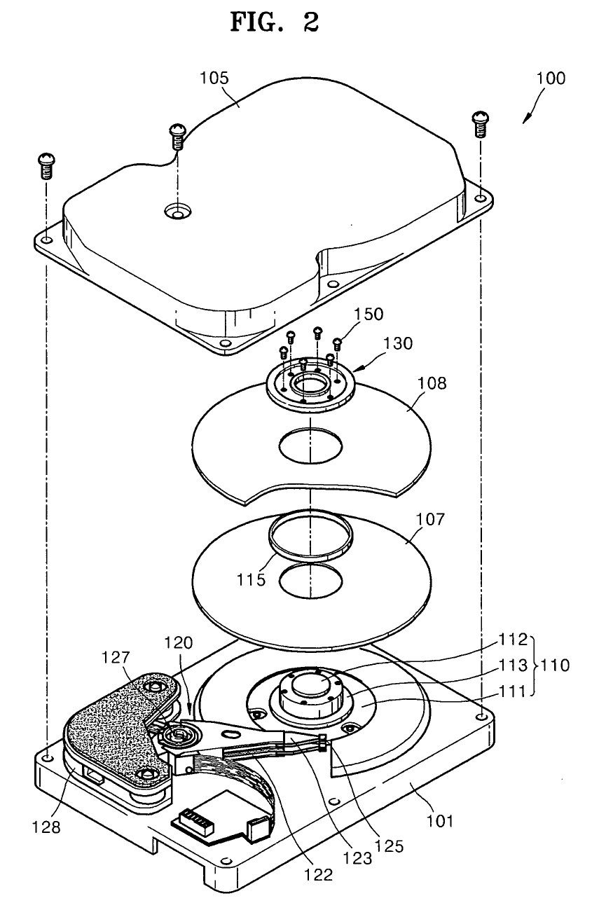

FIG. 2 is a perspective view illustrating a hard disk drive 100 according to an embodiment of the present general inventive concept.

Referring to FIG. 2, the hard disk drive 100 according to the current embodiment of the present general inventive concept includes a housing with a predefined internal space which includes a base member 101 and a cover member 105 that combines together. Arranged within the housing are first and second disks 107 and 108, both of which serve as a data recording medium, a spindle motor 110 to rotate the first and second disks 107 and 108, and an actuator 120. The base member 101 and the cover member 105 can be formed of stainless steel or aluminum. However, other materials that perform the intended operations of the present general inventive concept may be used alternatively.

The spindle motor 110 includes a motor bracket 111 securely fixed to the base member 101, a motor hub 113 to operate as a rotator, and a motor shaft 112 to operate as an axis of rotation about which the motor hub 113 rotates. The first and second disks 107 and 108 are stacked one above the other on the motor hub 113 with a spacer 115 interposed between the first and second disks 107 and 108 to space them apart from each other. A disk clamp 130 is fastened to a top surface of the motor hub 113 by a fastening means, such as, screws 150. The disk clamp 130 presses the first and second disks 107 and 108 against the motor hub 113, thus securing them in place.

The actuator 120 is a device that can write or read data to or from the first and second disks 107 and 108. The actuator 120 is pivotably mounted to the base member 101 and includes a swing arm 122 coupled to the base member 101 for pivotal movement about a pivot bearing 127, a suspension 123 attached to a distal end of the swing arm 122 and a slider 125 supported by the suspension 123. A magnetic head (not illustrated) to write and read data is attached to the slider 125.

In addition, the actuator 120 includes a voice coil motor 128 that provides a driving power to cause pivotal movement of the swing arm 122. The voice coil motor 128 is controlled by a servo control system and causes the swing arm 122 to rotate in a direction given by Fleming's left-hand rule under the interaction between an input current applied to a coil (not illustrated) of the voice coil motor 128 and a magnetic field created by a magnet (not illustrated). In response, the slider 125 attached to the distal end of the suspension 123 is moved over the first and second disks 107 and 108 toward the spindle motor 110 or toward an outer periphery of each of the first and second disks 107 and 108.

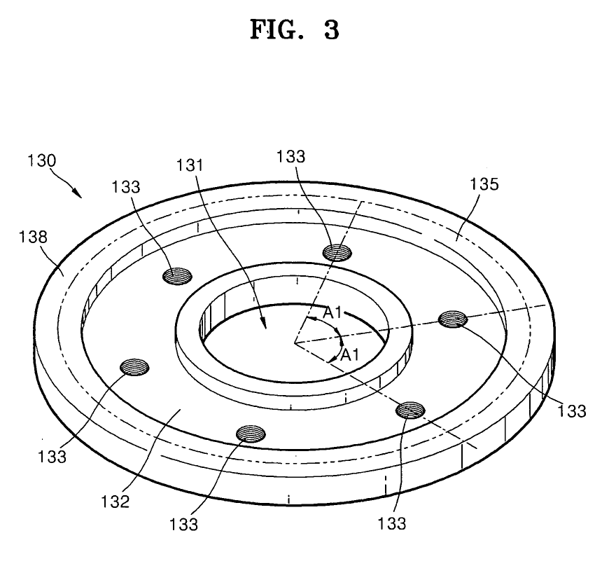

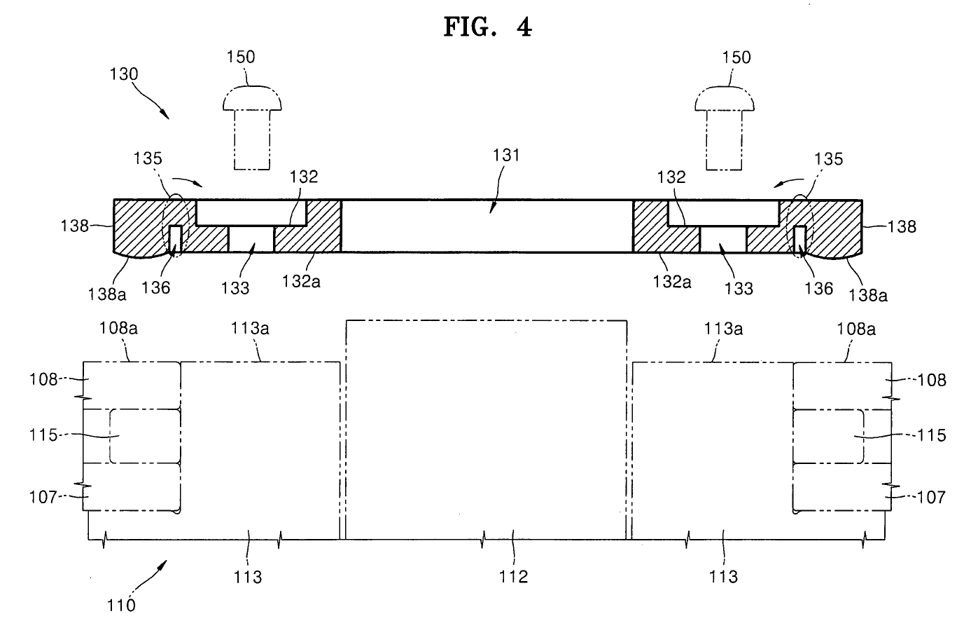

FIGS. 3 and 4 are perspective and cross-sectional views illustrating the disk clamp 130 according to an embodiment of the present general inventive concept.

Referring to FIGS. 3 and 4, the disk clamp 130 includes a bore 131 to receive of a top end of the motor shaft 112, a coupling part 132 provided around the bore 131, a pressing part 138 provided outside the coupling part 132 and an elastic deformation part 135 provided between the coupling part 132 and the pressing part 138. The disk clamp 130 is formed of a metallic material, such as spring steel or the like.

The coupling part 132 can be provided with six screw passage holes 133 through which screws 150 are inserted in order to fasten the coupling part 132 together with the motor hub 113. The screw passage holes 133 can be disposed at an equal angular spacing with respect to the center of the disk clamp 130 to make sure that the tightening forces of the screws 150 are uniformly distributed on the top end of the motor hub 113. Consequently, angles A1 of 60 degrees are made by each pair of adjoining screw passage holes 133 with respect to the center of the disk clamp 130 and are substantially the same within a tolerance range.

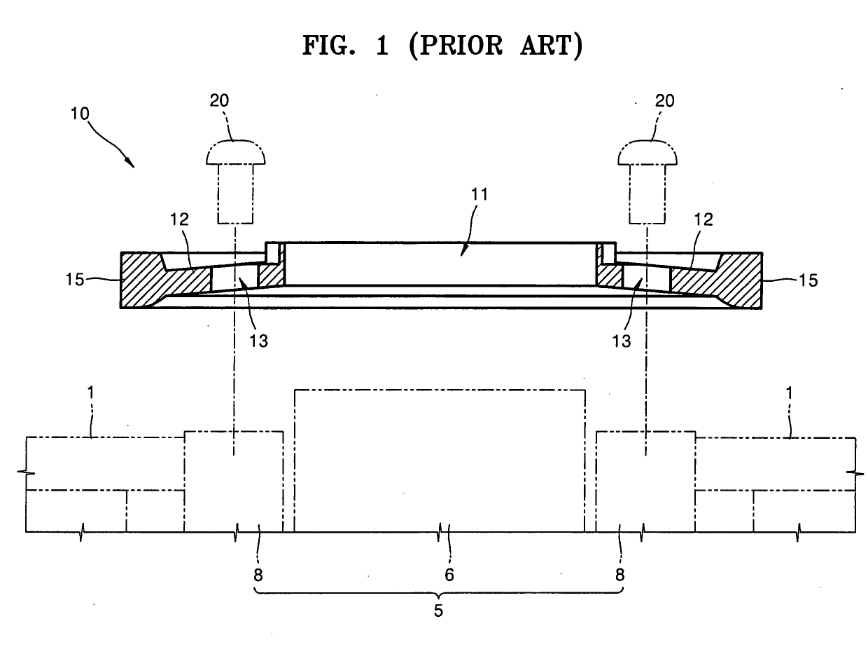

The motor hub 113 has a top planar surface 113a and the coupling part 132 also has a planar bottom surface 132a corresponding to the top planar surface 113a of the motor hub 113. In view of the fact that the top surface 113a of the motor hub 113 and the bottom surface 132a of the coupling part 132 are parallel to each other, the amount of vertical displacement of the coupling part 132 is not greater than that of the conventional disk clamp 10 illustrated in FIG. 1 when the screws 150 are tightened to fasten the disk clamp 130 to the motor hub 113.

By tightening the screws 150, the elastic deformation part 135 is flexed in a direction designated by an arrow in FIG. 4 in an elastically restorable manner, thus imparting a pressing force to the pressing part 138 so that the pressing part 138 can press the first and second disks 107 and 108. A groove 136 is formed in the elastic deformation part 135 to facilitate its flexing in the direction designated by the arrow or restoring itself in the opposite direction. The groove 136 is formed in the bottom surface of the elastic deformation part 135 and therefore can be observed when the disk clamp 130 is viewed from below. The disk clamp 130 according to the current embodiment of the present general inventive concept does not have a groove formed in the top surface of the elastic deformation part 135.

As the pressing force is imparted to the pressing part 138 by the flexural deformation of the elastic deformation part 135, the pressing part 138 presses the first and second disks 107 and 108 against the motor hub 113 to affix them in place. A bottom surface 138a of the pressing part 138 that makes contact with an inner peripheral part 108a of the second disk 108 has a downwardly convex shape such that its contact points and areas with the inner peripheral part 108a can be maintained uniform. Making the bottom surface 138a of the pressing part 138 into a convex shape helps to avoid any distortion of the inner peripheral part 108a which would otherwise occur due to the local concentration of a pressing load. The pressing part 138 has a greater thickness than the coupling part 132 and the elastic deformation part 135. This is to prevent any deformation of the pressing part 138 which would otherwise be caused by the repellent force of the inner peripheral part 108a of the second disk 108.

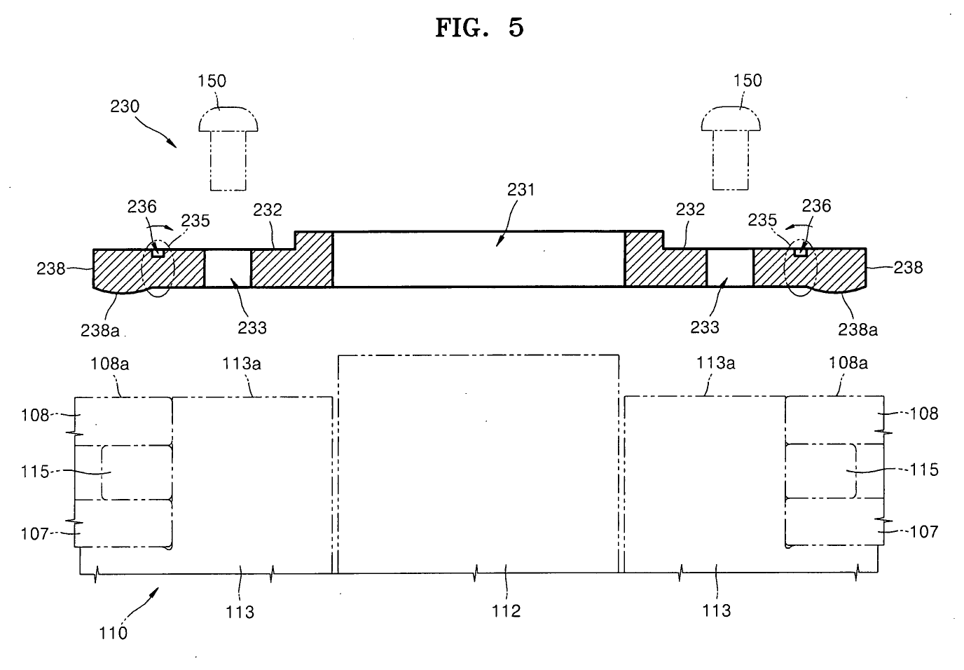

FIGS. 5 through 7 are cross-sectional views illustrating disk clamps 230, 330 and 430 according to additional embodiments of the present general inventive concept. The disk clamps 230, 330 and 430 may be employed in the hard disk drive 100 as an alternative to the disk clamp 130 illustrated in FIG. 2. These disk clamps 230, 330 and 430 are generally similar to, but differ in part from, the disk clamp 130 of the embodiment of FIGS. 3 and 4 set forth above. The following description will be centered on the differing parts of the disk clamps 230, 330 and 430.

Referring to FIGS. 5 through 7, each of the disk clamps 230, 330 and 430 includes a bore 231, 331 or 431 to receive a top end of the motor shaft 112 of the spindle motor 110, a coupling part 232, 332 or 432 provided around the bore 231, 331 or 431, a pressing part 238, 338 or 438 provided outside the coupling part 232, 332 or 432, and an elastic deformation part 235, 335 or 435 provided between the coupling part 232, 332 or 432 and the pressing part 238, 338 or 438. The coupling part 232, 332 or 432 is provided with six screw passage holes 233, 333 or 433 disposed at an equal angular spacing.

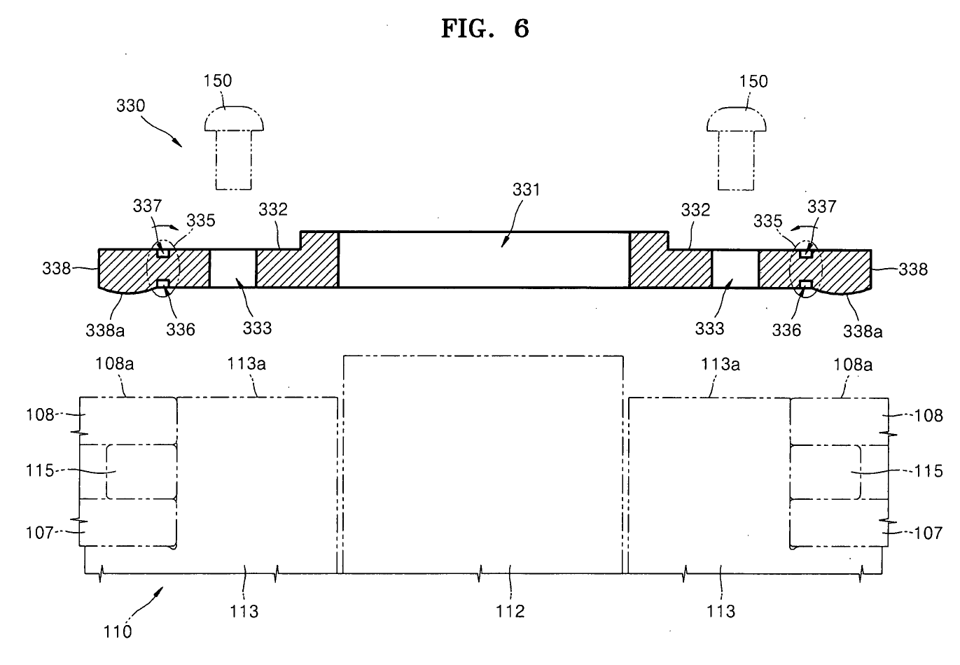

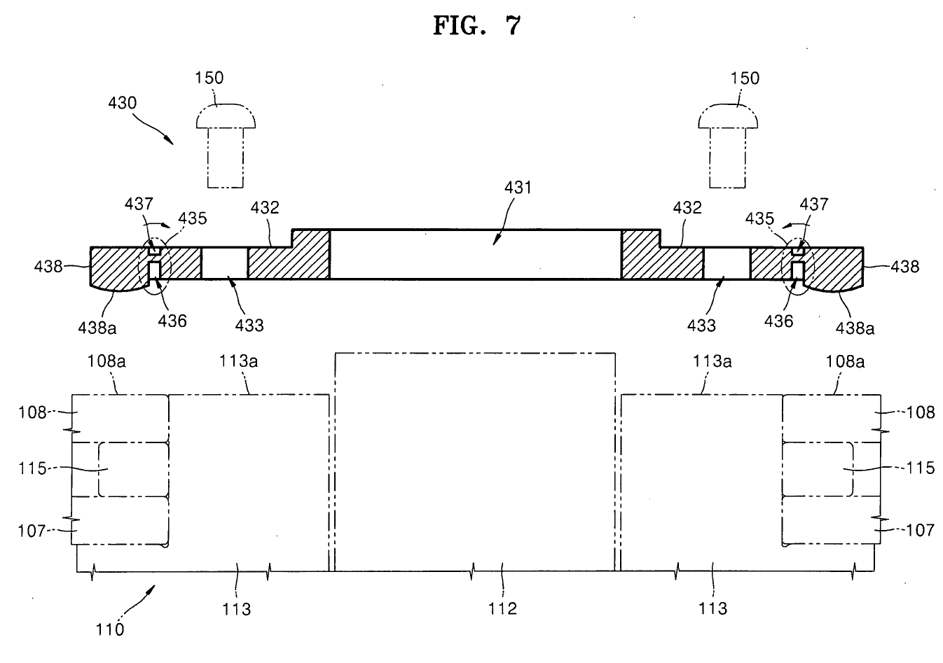

A bottom surface 238a, 338a or 438a of the pressing part 238, 338 or 438 that makes contact with an inner peripheral part 108a of the second disk 108 has a downwardly convex shape. The pressing part 238, 338 or 438 is thicker than the coupling part 232, 332 or 432 and the elastic deformation part 235, 335 or 435. The thickness of the coupling part 432 in the fourth embodiment is smaller than those of the coupling parts 232 and 332 according to the embodiments of FIGS. 5 and 6, which means that the bottom surface 438a of the pressing part 438 of the embodiment of FIG. 7 protrudes downwardly farther than the bottom surfaces 238a and 338a of the pressing parts 238 and 338 of the embodiments of FIGS. 5 and 6.

According to the embodiment as illustrated in FIG. 5, a groove 236 is formed in the top surface of the elastic deformation part 235 so that it can be observed when the disk clamp 230 is viewed from above. The groove 236 makes the thickness of the elastic deformation part 235 smaller than that of the coupling part 232 and the pressing part 238. According to the embodiment of FIG. 5, the disk clamp 230 does not have a groove formed in the bottom surface of the elastic deformation part 235.

In the disk clamps 330 and 430 of FIGS. 6 and 7, a first groove 336 or 436 is formed in the bottom surface of the elastic deformation part 335, or 435 and a second groove 337 or 437 is formed in the top surface of the elastic deformation part 335 or 435. The first groove 436 of the embodiment of FIG. 7 differs from the first groove 336 of the embodiment of FIG. 6 in that the former has a greater depth than the latter. The first groove 336 may be approximately the same size as the second groove 337. The first groove 436 may be larger than the second groove 437. The first groove 336 or 436 and the second groove 337 or 437 makes the thickness of the elastic deformation part 335 or 435 smaller than that of the coupling part 332 or 432 and the pressing part 338 or 438. In particular, the elastic deformation part 435 of the embodiment of FIG. 7 has a thickness far smaller than that of the elastic deformation part 335 of the embodiment of FIG. 6.

A computer simulation was conducted by the inventors of the present general inventive concept in order to comparatively prove the beneficial effects offered by the disk clamps 130, 230, 330, 430 of the various embodiments over the conventional disk clamp 10 illustrated in FIG. 1. In the simulation, an object hard disk drive having a couple of 69 mili-inch thick disks was used, with the assumption that six screws are tightened with a force of 3.5 kgfcm.

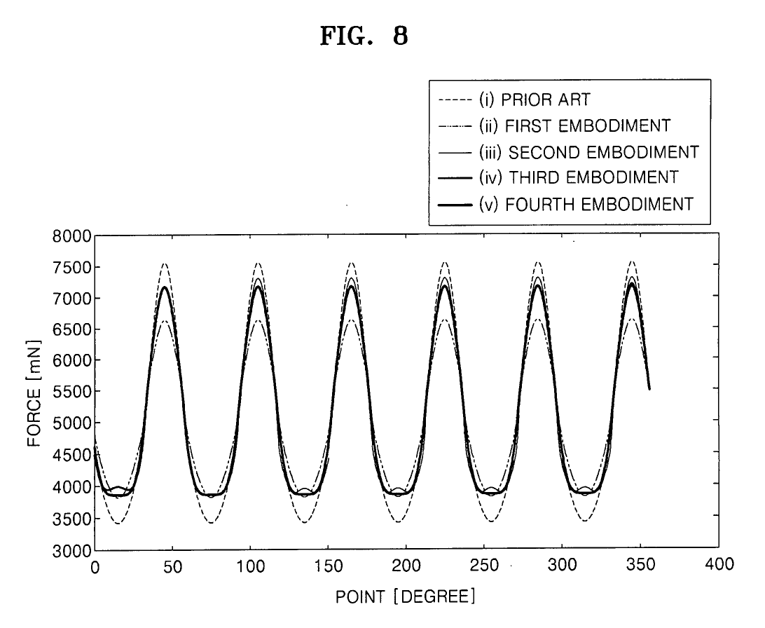

FIG. 8 is a graph illustrating simulation results illustrating the magnitude of pressing forces at specific points of a pressing part in a case in which the disk clamps 10, 130, 230, 330 and 430 are coupled to a spindle motor. More specifically, the abscissa in the graph represents specific points of the pressing part of the respective disk clamps 10, 130, 230, 330 and 430 angularly spaced apart with respect to the center of each of the disk clamps 10, 130, 230, 330 and 430, while the ordinate denotes the magnitude of the pressing forces applied to the inner peripheral parts of the disks at the specific points.

Referring to FIG. 8, curves (i) through (v) respectively corresponding to the prior art and the various embodiments of the present general inventive concept are generally sinusoidal such that each of the maximum pressing force and the minimum pressing force is repeated at a period of 60 degrees. Referring back to FIG. 3, the points exhibiting the maximum pressing force are the specific points of the pressing part 138 that lie on imaginary lines joining the center of the disk clamp 130 with the respective screw passage holes 133, whereas the points exhibiting the minimum pressing force are the specific points that lie between the maximum pressing force points. It can be seen in FIG. 8 that the prior art disk clamp 10 applies a severely fluctuating magnitude of pressing forces to the disk as indicated by the curve (i), but the disk clamps 130, 230, 330 and 430 according to the various embodiments of the present general inventive concept show relatively little fluctuation in the magnitude of pressing forces as designated by the curves (ii) through (v). In particular, the disk clamp 130 of the embodiment of FIGS. 3 and 4 reveals conspicuous reduction in the fluctuation of the magnitude of pressing forces. Table 1 illustrates the results of the simulation conducted by the inventors of the present general inventive concept.

TABLE 1

| | | Disk | Disk | Disk | Disk |
|---|---|---|---|---|---|
| | | Clamp | Clamp | Clamp | Clamp |
| | Prior Art | 130 | 230 | 330 | 430 |
| Displacement | 0.332 | 0.0972 | 0.2622 | 0.2663 | 0.3687 |
| Of Coupling Part | | | | | |
| (mm) | | | | | |
| Fluctuation Ratio | 1 | 0.6836 | 0.8261 | 0.7939 | 0.7998 |
| of Pressing | | | | | |
| forces | | | | | |

The displacement of coupling parts in Table 1 denotes the displacement by which the screw passage holes of the respective coupling part are moved downwards due to the tightening of screws. The disk clamp 130 of the embodiment of FIGS. 3 and 4 exhibits a displacement of the coupling part far smaller than those of the prior art disk clamp 10 and the disk clamps 230, 330 and 430 of the other embodiments. The displacement of the coupling part of the disk clamp 430 according to the embodiment of FIG. 7 is greater than that of the prior art disk clamp 10. This is because the pressing part 438 of the disk clamp 430 of the embodiment of FIG. 7 protrudes downwardly farther than the pressing parts 138, 238 and 338 of the disk clamps 130, 230 and 330 of the other embodiments, thus leaving an increased gap between the bottom surface 438a of the coupling part 432 and the top surface 113a of the motor hub 113 prior to tightening the screws 150. The coupling part 12 of the prior art disk clamp 10 is elastically deformed from a concave shape into a planar shape to thereby displace the screw passage holes 13 downwards. In contrast, the coupling part 432 of the disk clamp 430 of the embodiment of FIG. 7 continues to keep its shape planar as it is caused to move downwards. This means that there is less chance of tightening the screws 150 in a wrong fashion in the disk clamp 430 of the embodiment of FIG. 7 than in the prior art disk clamp 10.

The fluctuation ratio of pressing forces in Table 1 denotes a ratio of the difference between the maximum pressing force and the minimum pressing force in the disk clamps 130, 230, 330 and 430 of the various embodiments to the difference between the maximum pressing force and the minimum pressing force in the conventional disk clamp 10. Through this fluctuation ratio, it can be appreciated that the pressing force variation in the disk clamps 130, 230, 330 and 430 of the various embodiments is smaller than that of the conventional disk clamp 10. In particular, the pressing force variation is smallest in the disk clamp 130 of the embodiment of FIGS. 3 and 4. This means that, as compared to the conventional disk clamp 10, the disk clamps 130, 230, 330 and 430 of the present general inventive concept are capable of applying a relatively uniform pressing force to the inner peripheral part of the disk.

The extent of elastic deformation is smaller in the coupling parts of the disk clamps of the present general inventive concept than in the coupling part of the conventional disk clamp. This helps to avoid any inadvertent loosening of the screws and hence eliminates slippage of the disk.

Moreover, as compared to the conventional disk clamp, the disk clamps of the present general inventive concept allow a uniform pressing force to be applied to the inner peripheral part of the disk, thereby suppressing any unwanted distortion or deformation of the disk.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A disk clamp to affix a disk of a hard disk drive to a spindle motor, comprising:
a coupling part to couple to an upper portion of the spindle motor with screws;
a pressing part provided outside the coupling part to press the disk against the spindle motor; and
an elastic deformation part provided between the coupling part and the pressing part and adapted to be flexed in an elastically restorable manner when the screws are tightened to impart a pressing force to the pressing part.

2. The disk clamp of claim 1, wherein the coupling part has a bottom planar surface corresponding to a top planar surface of the spindle motor.

3. The disk clamp of claim 1, wherein the pressing part has a disk contact surface having a downwardly convex shape.

4. The disk clamp of claim 1, wherein the elastic deformation part is provided with a groove facilitating the flexing of the elastic deformation part.

5. The disk clamp of claim 4, wherein the groove is formed in a bottom surface of the elastic deformation part.

6. The disk clamp of claim 5, wherein no groove is formed in a top surface of the elastic deformation part.

7. The disk clamp of claim 1, wherein the elastic deformation part is provided with at least one groove facilitating the flexing of the elastic deformation part.

8. The disk clamp of claim 7, wherein the at least one groove includes a groove formed in a top surface of the elastic deformation part and a groove formed in a bottom surface of the elastic deformation part.

9. The disk clamp of claim 5, wherein the groove on the bottom surface of the elastic deformation part is approximately half the thickness of the coupling part.

10. The disk clamp of claim 8, wherein the groove on the top surface of the elastic deformation part is less than one-quarter the thickness of the coupling part.

11. The disk clamp of claim 8, wherein the groove on the bottom surface of the elastic deformation part is approximately the same size as the groove on the top surface of the elastic deformation part.

12. The disk clamp of claim 8, wherein the groove on the bottom surface of the elastic deformation part is larger than the groove on the top surface of the elastic deformation part.

13. The disk clamp of claim 1, wherein the elastic deformation part has a smaller thickness than the coupling part and the pressing part.

14. The disk clamp of claim 1, wherein the pressing part has a greater thickness than the coupling part and the elastic deformation part.

15. The disk clamp of claim 1, wherein the coupling part is provided with a plurality of screw passage holes disposed at an equal angular spacing.

16. A hard disk drive comprising at least one data-recording disk, a spindle motor rotating the disk and a disk clamp affixing the disk to the spindle motor, wherein the disk clamp comprises:
a coupling part to couple to an upper portion of the spindle motor with screws;
a pressing part provided outside the coupling part to press the disk against the spindle motor; and
an elastic deformation part provided between the coupling part and the pressing part and adapted to be flexed in an elastically restorable manner when the screws are tightened to impart a pressing force to the pressing part.

17. The hard disk drive of claim 16, wherein the spindle motor has a top planar surface and the coupling part has a bottom planar surface corresponding to the top planar surface of the spindle motor.

18. The hard disk drive of claim 16, wherein the pressing part has a disk contact surface having a downwardly convex shape.

19. The hard disk drive of claim 16, wherein the elastic deformation part is provided with a groove facilitating the flexing of the elastic deformation part.

20. The hard disk drive of claim 19, wherein the groove is formed in a bottom surface of the elastic deformation part.

21. The hard disk drive of claim 20, wherein no groove is formed in a top surface of the elastic deformation part.

22. The hard disk drive of claim 16, wherein the elastic deformation part is provided with at least one groove facilitating the flexing of the elastic deformation part.

23. The hard disk of claim 22, wherein the at least one groove includes a groove formed in a top surface of the elastic deformation part and a groove formed in a bottom surface of the elastic deformation part.

24. The hard disk of claim 23, wherein the groove on the bottom surface of the elastic deformation part is approximately the same size as the groove on the top surface of the elastic deformation part.

25. The hard disk of claim 23, wherein the groove on the bottom surface of the elastic deformation part is larger than the groove on the top surface of the elastic deformation part.

26. The hard disk drive of claim 16, wherein the elastic deformation part has a smaller thickness than the coupling part and the pressing part.

27. The hard disk drive of claim 16, wherein the pressing part has a greater thickness than the coupling part and the elastic deformation part.

28. The hard disk drive of claim 16, wherein the coupling part is provided with a plurality of screw passage holes disposed at an equal angular spacing.

29. A disk clamp comprising:
a coupling part including a plurality of screw holes to fasten screws therethrough to a spindle motor; and
a pressing part extending along the outer surface of the coupling part and including a first portion contacting the coupling part to have a thickness less than that of the coupling part and a second portion at the outer surface of the first portion and having a thickness greater than that of the coupling portion.

30. The disk clamp of claim 29, wherein the first portion has a bottom surface stepped up from a bottom surface of the coupling part.

31. The disk clamp of claim 29, wherein the first portion has a top surface stepped down from a top surface of the coupling part.

32. The disk clamp of claim 29, wherein the first portion has a bottom surface stepped up from a bottom surface of the coupling part and a top surface stepped down from a top surface of the coupling part.

33. The disk clamp of claim 32, wherein the stepped up bottom surface of the first portion is approximately the same size as the stepped down top surface of the first portion.

34. The disk clamp of claim 32, wherein the stepped up bottom surface of the first portion is larger than the stepped down top surface of the first portion.
